(19) United States
(12) Patent Application Publication
(10) Pub. No.: US 2006/0256678 A1
(43) Pub. Date: Nov. 16, 2006

(54) Write strategy for a data storage system

(75) Inventor: Rob Otte, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/569,176

(22) PCT Filed: Aug. 9, 2004
(86) PCT No.: PCT/IB04/51426

§ 371 Date: Feb. 22, 2006

(30) Foreign Application Priority Data
Aug. 27, 2003 (EP) 03103231.1

(51) Int. Cl. G11B 7/12

(52) U.S. Cl. 369/47.5

(57) ABSTRACT

A device for recording information in a track on a record carrier writes and reads marks that represent the information. A radiation source control unit (29) controls the power of the radiation source during said writing via power patterns. The marks have a number of different shapes due to different power patterns. The power pattern for at least one of the different shapes comprising a first pulse part for writing a first mark section (34) and a second pulse part for writing a second mark section (36), and an intermediate pulse part for creating a spacing section (35) between the first and second mark sections, and the sections of the mark being detectable as a single mark during said reading.

The invention relates to a device for recording information in a track on a record carrier, the device comprising a head for generating a beam of radiation for writing and reading marks.

The invention further relates to a method of controlling the power of a radiation source during recording information in a track on a record carrier.

The invention further relates to a record carrier comprising a track.

A device and method for recording information on a record carrier are known from WO 01/57856. The record carrier is of a recordable type and has a track for recording information, e.g. a spiral shaped track on a disc shaped carrier. For scanning the track an optical head is positioned at the track by a positioning unit. The head has a laser and optical elements for generating a beam of radiation for writing marks. The marks are physical patterns that represent the information and are optically detectable. By generating a read signal at different levels, e.g. 8 levels representing 3 bits per mark, such a mark may represent a symbol in a multi level storage system. A system is described for controlling the laser power defining control parameters for a power pulse pattern for writing a mark The interference of preceding and following marks, so called inter symbol interference (ISI), is compensated by adjusting the write parameters. In the known device a write strategy matrix is derived that maps a plurality of input sequences to a plurality of write strategy parameters. The input sequences each include a plurality of consecutive input data elements, such as the current, previous and next symbol value. When an input sequence is received, the write strategy matrix is used to determine a selected write strategy parameter for writing the current mark that corresponds to the input sequence. A problem is that the write strategy parameters cannot be chosen for minimizing the inter symbol interference and also, at the same time, for achieving an optimum signal level.

It is an object of the invention to provide a recording device and corresponding method and record carrier for achieving marks that generate read signals having a controllable level and shape, while repressing inter symbol interference.

For this purpose, the device as described in the opening paragraph has radiation source control means for generating power patterns for controlling the power of the radiation source during writing of marks having a number of different shapes for representing the information, the power pattern for at least one of the different shapes comprising a first pulse part for writing a first mark section and a second pulse part for writing a second mark section, and an intermediate pulse part for creating a spacing section between the first and second mark sections, and the sections of the mark being detectable as a single mark during said reading.

The method as described in the opening paragraph comprises generating power patterns for controlling the power of the radiation source during writing of marks having a number of different shapes for representing the information, the power pattern for at least one of the different shapes comprising a first pulse part for writing a first mark section and a second pulse part for writing a second mark section, and an intermediate pulse part for creating a spacing section between the first and second mark sections, and the sections of the mark being detectable as a single mark during said reading.

In the record carrier as described in the opening paragraph the track comprises marks having a number of different shapes for representing information, at least one of the different shapes comprising a first mark section, a second mark section, and a spacing section between the first and second mark sections, and the sections of the mark being detectable as a single mark during reading.

The effect of the measures is that a single mark is detected during reading, but the shape and level of the read signal is controlled by both mark sections and the spacing section. Via the power pattern the mark and spacing sections of the mark are created during writing. The presence of a spacing section within the mark (although not detectable as such while reading) provides a degree of freedom in the shape of the mark, which is available to adjust the shape and level of the read signal in a desired pattern and also repress inter symbol interference.

The invention is also based on the following recognition. In recent optical recording systems multi level codes are used. Multi level codes require read signals at different signal levels from a single mark, and the marks written on the recording medium are often thought of as different levels of grey. The grey levels correspond to the levels of the read signal. However, physically, grey cannot be written due to the nature of the recording medium, e.g. phase change material is either in a crystalline or amorphous state, magnetization is either up or down in magnetic system, etc. The inventors have seen that information in multilevel recording is contained in the shape of the marks rather than in the reflectivity. In particular, the information is contained in the length of marks resulting in different read signal levels. Because the length of the mark is set for achieving the required signal level at a read-out time, an additional adjustment is required for influencing the signal shape and level at other relevant moments, i.e. at the read-out times of preceding and succeeding symbols, for reducing inter symbol interference. Equalization is usually applied in the receiver to restore the required signal levels and reduce inter symbol interference. The equalization is optimized for a specific expected read signal shape. Hence preceding and succeeding marks of different shapes will cause residual inter symbol interference. By including at least one spacing section in marks of at least some lengths, the inventors have created the additional freedom for influencing the read signal level and shape at read-out time of neighboring symbols.

In an embodiment of the device the radiation source control means are for generating the power patterns for generating different levels of a read signal at a read-out time for said number of different shapes. The additional parameter of the spacing section can advantageously be used to generate different signal levels. However it is to be noted that the spacing section may also be used in a different read-out system to more accurately position a further read signal parameter, e.g. a zero crossing in a binary read-out system.

In an embodiment of the device the radiation source control means are for generating the power patterns adapted for repressing interference from preceding or succeeding marks in dependence of a predefined read channel. This has the advantage that the inter symbol interference is reduced based on a read channel that is expected to be used for recovering the information.

In an embodiment of the device the power patterns are generated for said repressing in dependence of a predetermined read signal equalizing function. This has the advantage that the effect of the write strategy and the effect of the read signal equalizing function are combined, and can be optimized together.

In an embodiment of the device said number of different shapes comprises longer and shorter shapes, and the predetermined read signal equalizing function is adapted to improve the read signal for the longer shapes, in particular optimized for the longest shape. Adapting the read signal equalizing function to the longer shapes has the effect that output level and inter symbol interference for the longer marks is corrected by the equalizer. Hence the largest uncorrected signal interference is caused by mid size shapes, which can be easily divided for including the spacing section.

In an embodiment of the device said number of different shapes comprises a longest shape, and the radiation source control means are for generating the power pattern for the longest shape as a continuous mark without a spacing section. In a level sensitive system the longest mark is required to generate the strongest read signal. Not dividing the longest mark has the advantage that the maximal contrast available from the readout unit is not degraded.

Further embodiments are given in the dependent claims.

These and other aspects of the invention will be apparent from and elucidated further with reference to the embodiments described by way of example in the following description and with reference to the accompanying drawings, in which

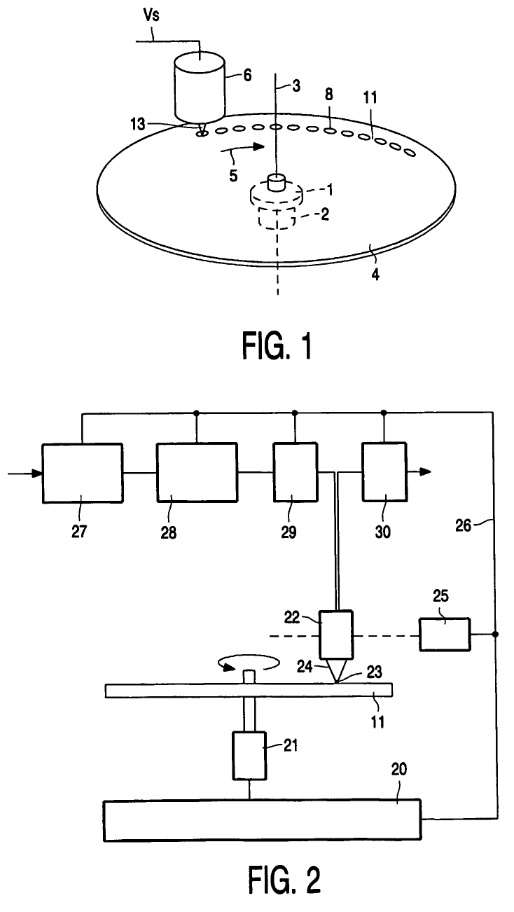

FIG. 1 shows diagrammatically an optical recording process,

FIG. 2 shows a recording device,

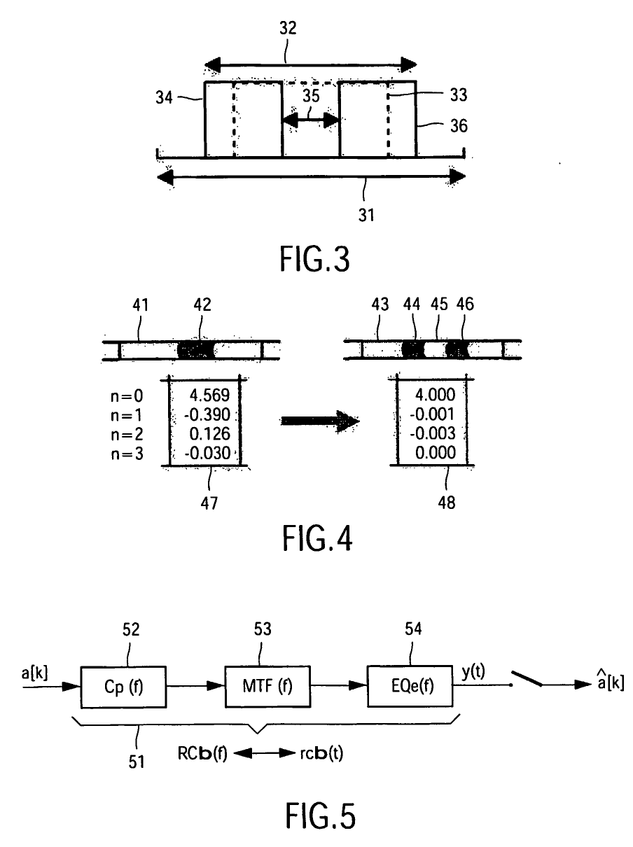

FIG. 3 shows schematically a mark having mark sections,

FIG. 4 shows a comparison of a single mark and a subdivided mark,

FIG. 5 shows a model for the channel of a multilevel storage system,

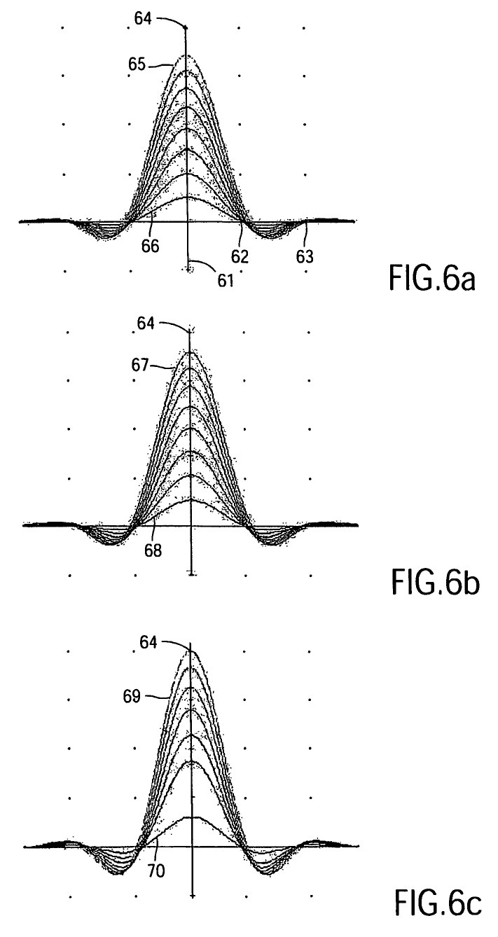

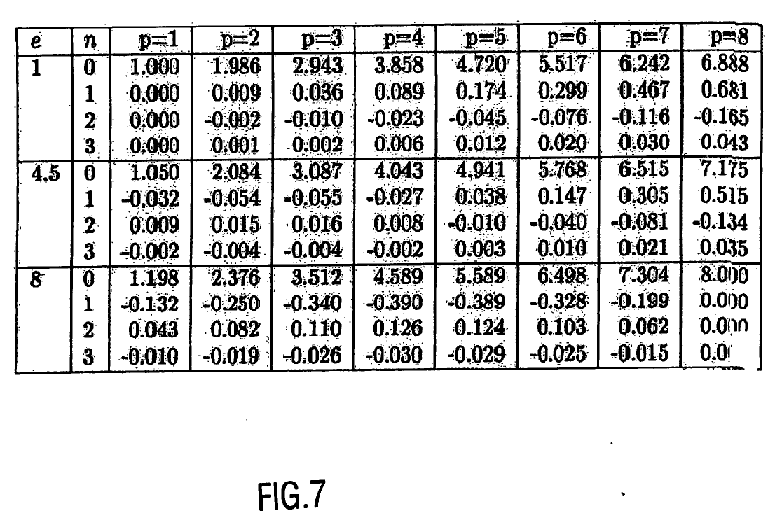

FIG. 6 shows pulses after equalization,

FIG. 6a shows pulses using an equalizer optimized for a minimum length pulse,

FIG. 6b shows pulses using an equalizer optimized for a medium length pulse,

FIG. 6c shows pulses using an equalizer optimized for a maximum length pulse,

FIG. 7 shows inter symbol interference values dependent on the equalizer,

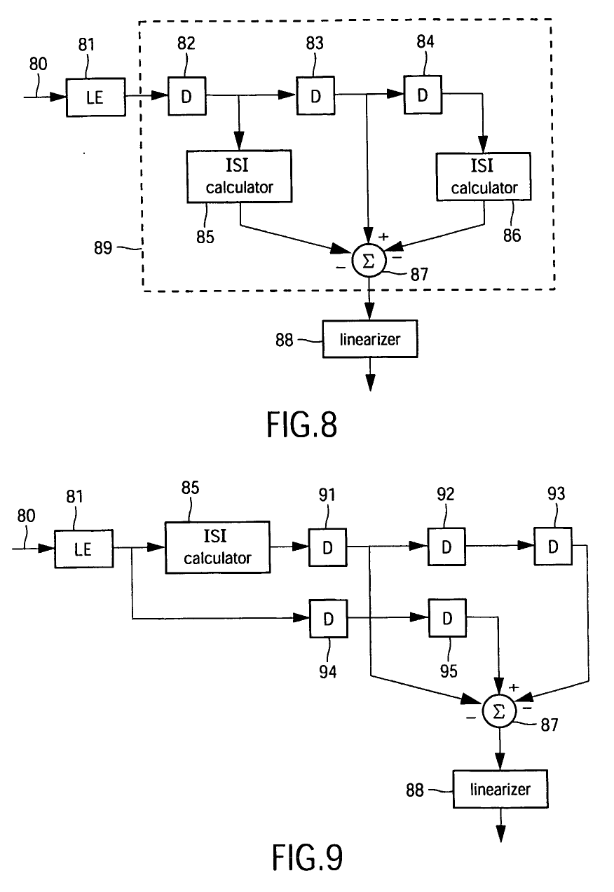

FIG. 8 shows read signal equalization,

FIG. 9 shows an alternative circuit for read signal equalization,

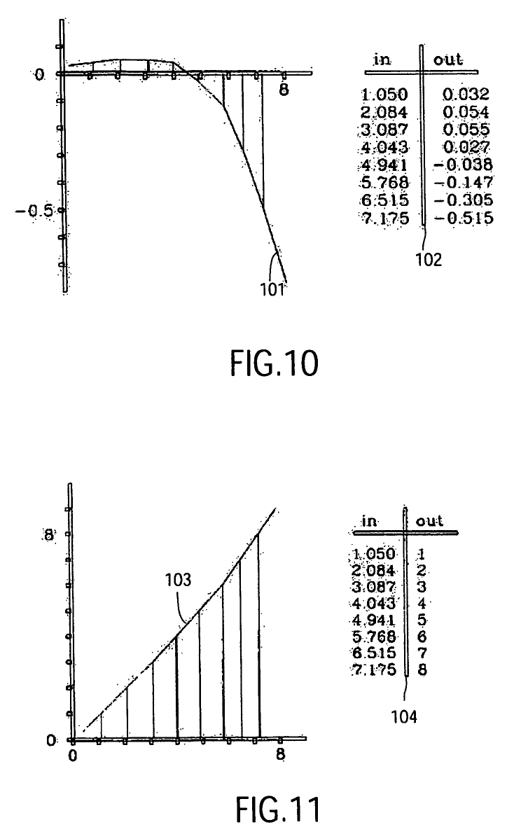

FIG. 10 shows correction values for an ISI calculator, and

FIG. 11 shows correction values for a linearizer.

Corresponding elements in different Figures have identical reference numerals.

FIG. 1 shows diagrammatically an optical recording process. Relevant elements of a recording device are shown comprising a turntable 1 and a drive motor 2 for rotating a disc shaped record carrier 4 about an axis 3 in a direction indicated by an arrow 5. The record carrier has a track 11 for recording marks 8, the track being located by a servo pattern for generating servo tracking signals for positioning an optical head opposite the track. The servo pattern may for example be a shallow wobbled groove, usually called a pre-groove, and/or a pattern of indentations, usually called pre-pits or servo pits. The record carrier 4 comprises a radiation-sensitive recording layer which upon exposure to radiation of sufficiently high intensity is subjected to an optically detectable change, such as for example a change in reflectivity, for forming marks 8 constituting a recorded pattern representing information. In the recorded pattern the marks have a specific shape, which represent the information. The representation may be according to a modulation scheme usually called channel code.

The radiation-sensitive layer may comprise, for example, a thin metal layer which can be removed locally by exposure to a laser beam of comparatively high intensity. Alternatively, the recording layer may consist of another material such as a radiation sensitive dye or a phase-change material, whose structure can be changed from amorphous to crystalline or vice versa under the influence of radiation. An optical write head 6 is arranged opposite the track of the (rotating) record carrier. The optical write head 6 comprises a radiation source, for example a solid-state laser, for generating a write beam 13. The intensity I of the write beam 13 is modulated in conformity with a control signal in a customary manner. The intensity of the write beam 13 varies between a write intensity, which is adequate to bring about detectable changes in the optical properties of the radiation-sensitive record carrier for forming marks and intermediate areas in between the marks further called space. In a write system a low (or zero) intensity, which does not bring about any detectable changes, may be used for creating spaces. High density rewriting systems using phase change material are usually based on a direct overwrite (DOW) writing. Therefore when a space is to be written, some write pulse is required to erase possible previous data on the disc. Usually, a melt pulse (high power) is given, followed by a lower level for a particular period to obtain (partial) regrowth of a crystalline area into the previously molten area. The marks may be in any optically readable form, e.g. in the form of areas with a reflection coefficient different from their surroundings, obtained when recording in materials such as dye, alloy or phase change material, or in the form of areas with a direction of magnetization different from their surroundings, obtained when recording in magneto-optical material.

The system of controlling the write power for creating a mark is adapted to the pattern that has to be recorded, which is called a write strategy. In high density recording sophisticated write strategies are implemented to generate power patterns having a controllable shape, e.g. controlling the write power pattern in dependence of the length of the mark to be written and/or size of the preceding space. The parameters in the write strategy that determine the power pattern in dependence of time and the marks to be recorded are called settings of the write strategy. In particular the write strategy is arranged to generate a power pattern in dependence of the shapes of the marks to be recorded. In particular for at least one of the different shapes the power pattern has a first pulse part for writing a first mark section and a second pulse part for writing a second mark section, and an intermediate pulse part for creating a spacing section between the first and second mark sections, and the sections of the mark being detectable as a single mark during said reading.

For reading the recording layer is scanned with a beam 13 whose intensity is at a reading level of a constant intensity which is low enough to preclude a detectable change in optical properties. During scanning the read beam reflected from the record carrier is modulated in conformity with the information pattern being scanned. The modulation of the read beam can be detected in a customary manner by means of a radiation-sensitive detector which generates a read signal which is indicative of the beam modulation.

FIG. 2 shows a recording device for writing and/or reading information on a record carrier 11 of a type which is writable or re-writable, for example CD-R or CD-RW, or a recordable DVD. The device is provided with scanning means for scanning the track on the record carrier which means include a drive unit 21 for rotating the record carrier 11, a scanning unit 22 comprising an optical head and additional circuitry, a positioning unit 25 for coarsely positioning the optical head in the radial direction on the track, and a control unit 20. The optical head comprises an optical system of a known type for generating a radiation beam 24 guided through optical elements focused to a radiation spot 23 on a track of the information layer of the record carrier. The optical head and additional circuits constitute a scanning unit for generating signals detected from the radiation beam. The radiation beam 24 is generated by a radiation source, e.g. a laser diode. The head further comprises (not shown) a focusing actuator for moving the focus of the radiation beam 24 along the optical axis of said beam and a tracking actuator for fine positioning of the spot 23 in a radial direction on the center of the track. The tracking actuator may comprise coils for radially moving an optical element or may alternatively be arranged for changing the angle of a reflecting element. For writing information the radiation is controlled to create optically detectable marks in the recording layer. For reading the radiation reflected by the information layer is detected by a detector of a usual type, e.g. a four-quadrant diode, in the optical head for generating a read signal and further detector signals including a tracking error and a focusing error signal for controlling said tracking and focusing actuators. The read signal is processed by read processing unit 30 including a demodulator, deformatter and output unit of a usual type to retrieve the information. Hence retrieving means for reading information include the drive unit 21, the optical head, the positioning unit 25 and the read processing unit 30. The device comprises write processing means for processing the input information to generate a write signal to drive the optical head, which means comprise an input unit 27, and a formatter 28 and a laser power unit 29. The control unit 20 controls the recording and retrieving of information and may be arranged for receiving commands from a user or from a host computer. The control unit 20 is connected via control lines 26, e.g. a system bus, to said input unit 27, formatter 28 and laser power unit 29, to the read processing unit 30, and to the drive unit 21, and the positioning unit 25. The control unit 20 comprises control circuitry, for example a microprocessor, a program memory and control gates, for performing the writing and/or reading functions. The control unit 20 may also be implemented as a state machine in logic circuits.

The control unit 20 is connected via control lines 26, e.g. a system bus, to said input unit 27, formatter 28 and laser power unit 29, to the read processing unit 30, and to the drive unit 21, and the positioning unit 25. The control unit 20 comprises control circuitry, for example a microprocessor, a program memory and control gates, for performing the procedures and functions according to the invention as described below. The control unit 20 may also be implemented as a state machine in logic circuits.

In an embodiment the recording device is a storage system only, e.g. an optical disc drive for use in a computer. The control unit 20 is arranged to communicate with a processing unit in the host computer system via a standardized interface. Digital data is interfaced to the formatter 28 and the read processing unit 30 directly.

In an embodiment the device is arranged as a stand alone unit, for example a video recording apparatus for consumer use. The control unit 20, or an additional host control unit included in the device, is arranged to be controlled directly by the user, and to perform the functions of the file management system. The device includes application data processing, e.g. audio and/or video processing circuits. User information is presented on the input unit 27, which may comprise compression means for input signals such as analog audio and/or video, or digital uncompressed audio/video. Suitable compression means are for example described for audio in WO 98/16014-A1 (PHN 16452), and for video in the MPEG2 standard. The input unit 27 processes the audio and/or video to units of information, which are passed to the formatter 28. The read processing unit 30 may comprise suitable audio and/or video decoding units.

The formatter 28 is for adding control data and formatting and encoding the data according to the recording format, e.g. by adding error correction codes (ECC), interleaving and channel coding. Further the formatter 28 comprises synchronizing means for including synchronizing patterns in the modulated signal. The formatted units comprise address information and are written to corresponding addressable locations on the record carrier under the control of control unit 20. The formatted data from the output of the formatter 28 is passed to the laser power unit 29.

The laser power unit 29 receives the formatted data indicating the marks to be written and generates a laser power control signal which drives the radiation source in the optical head. For multilevel recording different marks are used to generate different levels of the read-out signal during read-out at a specific read-out time. The track is subdivided in cells of a constant length, and each cell contains a mark representing one of a number of signal levels. Traditionally the marks are considered as gray. However, due to the nature of the physical phenomena used to form the marks, grey is not the physical constitution of the mark. Actually the read signal level of traditional multilevel systems is generated by different shapes of the marks, in particular the length. The laser power unit 29 is arranged for generating a power pattern for accurately writing marks of a preferred shape. The different lengths of a mark are not detected as such, but as different levels of the read signal value of a symbol in a cell, because the size of a radiation spot for detecting the contents of a cell is about the size of the cell itself In other words, the size of the symbol (the cell) is selected a small as possible with respect to the detection system. In practice the radiation spot will also detect some of the contents of the neighboring cells, which causes inter symbol interference (ISI). Linear ISI can be compensated by linear equalization, provided that the Nyquist requirement is met. This requirement says that the symbol rate should be less than twice the bandwidth of the system. In our case, the symbol rate is fsymbol and the bandwidth is the optical cutoff being fc=2NA/lambda, so we find that ISI can be fully eliminated (i.e. full response system) provided that fsymbol=<4NA/lambda). Non-linear ISI occurs in practical high-density systems.

A method to reduce or cancel non-linear ISI and linearize the system is by adapting the marks on the disc. Instead of writing a single mark having different mark lengths, a mark is subdivided in a multitude mark sections. The mark sections are not detectable separately due to the size of the read out detection, e.g. the size of the read-out spot of an optical pickup unit. In other words, the mark sections have a high frequency, and therefore the individual mark sections will not pass trough the read channel. The overall read signal gives a good approximation of ‘grey’.

For a range of different marks, e.g. having lengths corresponding to read signal levels 1 to 8, subdividing may not be applied for all mark lengths. Of course a cell without a mark (signal level zero) may be included, which obviously cannot be subdivided. For example the shortest written mark (p=1) cannot be split up into series of even shorter marks due to technical limitations. For the longest marks (p=8) splitting up would reduce the maximum signal level, i.e. reduce the dynamic signal range. Hence the longest mark may be written as a continuous mark. In practice mainly the marks of moderate length are subdivided. The principle of multi mark writing is illustrated in FIGS. 3 and 4 taking a pulse of moderate length (p=4).

The laser power unit 29 is arranged for writing a mark as a sequence of mark sections and space sections, e.g. amorphous and crystalline sections in a phase change recording layer. The inventors have seen that for example in high density, fast growth phase change material mark sections can be created that are smaller than a writing laser spot. Via a power pattern that turns the radiation substantially on and off multiple times during writing a mark sections of different constitution are formed, e.g. crescent shaped amorphous mark sections alternating with crystalline space sections.

FIG. 3 shows schematically a mark having mark sections. On a horizontal axis an available cell 31 for a mark is indicated by an arrow. The available cell is for recording a mark representing a symbol. In a multilevel system the read signal of the mark may for example have 8 levels; such a mark can represent 3 bits. A maximum length mark would substantially fill the cell, and the level would be p=8. A theoretical, traditional mark having a level p=4 (covering about 50% of the cell) is indicated by the dashed mark 33. According to the invention the actual mark is subdivided into mark sections, a first mark section 34, followed by a spacing section 35 and a second mark section 36. It is to be noted that during reading the mark (and spacing) sections cannot be detected separately, but a single read-out signal level is detected at a read-out time, usually centered in the cell 31. The cell length is called T, the overall length 32 of the sequence of mark sections is called Dₒᵥₑᵣₐₗₗ, and the spacing 35 is called D_{spacing}.

FIG. 4 shows a comparison of a single mark and a subdivided mark. A single mark 42 is shown on the left in a cell 41. Table 47 shows the value of the readout signal at the readout time (n=0) as calculated (discussed below with reference to FIGS. 5 to 7). Table 47 also shows the resulting inter symbol interference (n=1, 2, 3 for the next, second and third neighbor respectively) based on a presumption that an equalizer is used in the receiver that is optimized for the full-length mark (p=8). As a comparison on the right the same signal level (p=4) is achieved by a subdivided mark in cell 43. The subdivided mark has a first mark section 44, a spacing section 45 and a second mark section 46. The total read signal level is shown in Table 48 (top), and the resulting inter symbol interference is given also. It is to be noted that the 2 parameters (overall length and spacing section) can be tuned for cancellation of non-linearity and nearest neighbor ISI simultaneously. It shows that Doverall=0.8 T, Dspacing=0.3 T (as shown in FIG. 4) is close to optimal, i.e. level=4 and inter symbol interference values substantially zero. Non-linearity and nearest neighbor ISI are virtually absent. ISI in the further neighbors is also virtually absent, though this was not optimized. Pulses of other length may be optimized likewise. Further, the lengths of the mark sections and spacing sections have reasonable values for which a write strategy can easily be found.

For understanding the inter symbol interference a model for the channel of writing and reading of marks is discussed now. First, the residual ISI due to non-linear behavior of a pulse width (or duration) modulated (PWM) system is calculated. It is shown that the residual ISI is not negligible. The effects of ISI can be reduced by measures during writing (predistortion in the write channel), but also at read back, by non-linear equalization.

FIG. 5 shows a model for the channel of a multilevel storage system. A channel 51 is provided with input symbols represented by a[k], which are converted to a discrete-time waveform by passing them through a pulse modulator 52. The pulse modulator 52 is described by a Fourier pair cₚ(t) [symbol] Cₚ(f). In case of amplitude modulation, there is only one pulse shape used, which is modulated in amplitude by the aₖ. In case of pulse width modulation, different pulses of different duration are used, dependent on the symbols aₖ to be transmitted. The pulse is given by the Fourier pair:

$${c}_{p} ( t ) = Π ( \frac{t}{D} ) ⟷ {C}_{p} ( f ) = \frac{sin ( π fD )}{π f}$$

The block function II used above is defined according to:

$$Π ( \frac{t}{D} ) = \{ \begin{matrix}1 & for - \frac{D}{2} \leq t \leq \frac{D}{2} \\ 0 & elsewhere\end{matrix}$$

In pulse width modulation, the duration D depends on the symbol to be transmitted, e.g. according to

$$D = \frac{p}{M} T ,$$

in which M is the alphabet size,

$$T = \frac{1}{{f}_{symbol}}$$

is the symbol time, and p is the pulse index. The optical channel is specified by its modulation transfer function (MTF):

$$MTF ( f ) = \{ \begin{matrix}\frac{2}{π} arccos ( \frac{\vert f \vert}{{f}_{c}} ) - \frac{2 \vert f \vert}{π {f}_{c}} \sqrt{1 - {( \frac{\vert f \vert}{{f}_{c}} )}^{2}} for \vert f \vert \leq {f}_{c} \\ 0 for \vert f \vert > {f}_{c}\end{matrix} \}$$

in which

$${f}_{c} = \frac{2 NA}{λ}$$

is the optical cut-off of the channel (NA being numerical aperture of the lens and λ being the wavelength). The equalizer EQ is chosen such as to obtain an ISI-free (known as full-response, or FR) system. From the model as shown in FIG. 5 it is clear that the FR equalizer is pulse modulator dependent as the total response has to satisfy RCβ(f). The index e is used to emphasize that the equalizer belongs to pulse e. As the pulse is not known in advance, it is not possible to use the corresponding equalizer in the receiver. Consequently, a pulse width modulation system cannot be FR. Instead, the system will be non-linear and show residual ISI. By proper compensation, non-linearity and ISI can be made small. Compensation may be applied via precompensation in the write channel. However, compensation may also be done in the read channel, which is advantageous when it is not possible to accurately control the write channel (read only discs like ROM and R, or written discs like RW after ageing). Initially assuming a linear system, the channel is made ISI-free by using a transfer function showing vestigial symmetry around half the symbol rate (according to Nyquist). In the sequel, the so-called raised cosine response, or RC response for short, a commonly function for this purpose, is given by:

$${RC}_{β} ( f ) = \{ \begin{matrix}\frac{1}{{f}_{symbol}} & for 0 \leq \vert f \vert \leq \frac{1 - β}{2} {f}_{symbol} \\ \frac{1}{2 {f}_{symbol}} \{ 1 - sin [ \frac{π}{β} ( \frac{f}{{f}_{ symbol}} - \frac{1}{2} ) ] \} & for \frac{1 - β}{2} {f}_{symbol} \leq \vert f \vert \leq \frac{1 + β}{2} {f}_{symbol} \\ 0 & for \vert f \vert \geq \frac{1 + β}{2} {f}_{symbol} . . .\end{matrix}$$

The parameter β determines the excess bandwidth (0 ≦β≦1, β=0 corresponding to no excess bandwidth, i.e. sinc response channel, and β=1 corresponding to 100% excess bandwidth). Now the cut-off of the RC-function is put at the MTF cut-off (one may do another choice but this would mean throwing away some of the HF part of the MTF). Consequently, β is not longer an independent parameter, but rather directly coupled to the density on disc. It is given by:

$$β = \frac{2 {f}_{c} - {f}_{symbol}}{{f}_{symbol}}$$

Because β is no longer an independent parameter, it is dropped from the notation in those cases where the above value is used. Substitution yields:

$$RC ( f ) = \{ \begin{matrix}\frac{1}{{f}_{symbol}} & for 0 \leq \vert f \vert \leq {f}_{symbol} - {f}_{c} \\ \frac{1}{2 {f}_{symbol}} \{ 1 - sin [ \frac{π {f}_{symbol}}{2 {f}_{c} - {f}_{symbol}} ( \frac{f}{{f}_{ symbol}} - \frac{1}{2} ) ] \} & for {f}_{symbol} - {f}_{c} \leq \vert f \vert \leq {f}_{c} \\ 0 & for \vert f \vert \geq {f}_{c} . . .\end{matrix}$$

The equalizer yielding ISI-free response for pulse p is given by:

$${EQ}_{p} ( f ) = \frac{{RC}_{β} ( f )}{{C}_{p} ( f ) MTF ( f )}$$

If we now apply a different pulse, i.e. a pulse for which the equalizer was not made ISI free, residual ISI will result. Suppose the equalizer was made ISI-free for pulse e, while pulse p is applied, then the output pulse response function can be written as:

$$y ( t ) \begin{matrix}= {ℱ}^{- 1} \{ {C}_{p} ( f ) MTF ( f ) {EQ}_{e} ( f ) \} \\ = {ℱ}^{- 1} \{ \frac{{RC}_{β} ( f )}{{C}_{e} ( f )} {C}_{p} ( f ) \} \\ \end{matrix}$$

and this result suffers from ISI for p≠e.

FIG. 6 shows pulses after equalization. The pulses are plotted to get an impression of the type of non-linearity and ISI. For this purpose, a multilevel system was taken using M=8.

FIG. 6a shows pulses using an equalizer optimized for a minimum length pulse. The equalizer is optimized for p=1 using the above formulas. The pulse response y(t) for 8 different pulses is shown, the y-axis being the nominal read-out time 61. The signal values at a distance T are the residual ISI values at the read-out time of the neighboring cells: the next neighbor 62 and the second succeeding neighbor 63. The nominal maximum signal level 64 is indicated on the y-axis and corresponds to level=8. It can be seen that the pulse response 66 for level=1 has the nominal value of 1 at the y-axis due to the equalizer being determined for that pulse. The pulse response 65 for level=8 deviates substantially from the maximum level 64.

FIG. 6b shows pulses using an equalizer optimized for a medium length pulse. The equalizer is optimized for p=4.5 using the above formulas. The pulse response y(t) for 8 different pulses is shown as in FIG. 6a It can be seen that the pulse response 68 for level=1 has the nominal value of more than 1 at the y-axis due to the equalizer not being determined for that pulse. The pulse response 67 for level=8 deviates from the maximum level 64, but less than in FIG. 6a.

FIG. 6c shows pulses using an equalizer optimized for a maximum length pulse. The equalizer is optimized for p=8 using the above formulas. The pulse response y(t) for 8 different pulses is shown as in FIG. 6a. It can be seen that the pulse response 70 for level=1 has the nominal value of substantially more than 1 at the y-axis due to the equalizer not being determined for that pulse. The pulse response 69 for level=8 now exactly is at the maximum level 64.

FIG. 7 shows inter symbol interference values dependent on the equalizer. The table gives ISI values for three equalizers, optimized for e=1, e=4.5 and e=8. It is noted that the values in the table of FIG. 7 correspond to the pulse responses drawn in FIG. 6. The table shows for each equalizer the signal values at the nominal read-out time (n=0), and the ISI values at the next three neighbors (n=1, 2, 3) for eight different signal levels (pulse lengths p=1 tot p=8).

It is noted that the model only describes non-linear effects due to equalization of length modulated pulses. There are also other non linear effects, e.g. the read out of optical discs is intrinsically non-linear. However, as the effect under investigation is quite severe, the current channel model by means of a linear MTF is a practical tool. Further, the model assumes that marks are only modulated in length, and not in amplitude or shape. Measurements confirm that length modulation is the main effect in the current high density media (e.g. using fast cooling fast growth phase change material). Quantitative results, helpful when further optimizing the equalizer and the write method proposed in the next sections, can be obtained from studying thermal effects, scalar diffraction analysis and measurements.

From the above it is concluded that linearization and ISI compensation are required. Non-linearity as well as ISI appear to be not very dependent on density, though the effect tends to decrease slightly with density. The non-linear and ISI properties mainly are a property of the pulse length modulation system.

For read signal equalization the proposed compensation span is at least nearest neighbor (3 taps), but may be one more neighbor (5-taps) may further improve system performance. If the ISI is not too severe, an approximation of the ISI is made from a single sample (in which further ISI is neglected), followed by subtraction of this approximated value from the neighboring signal samples. For a system having more severe ISI the neighboring samples may be also included for calculating ISI correction values. The correction values may be calculated or a lookup table may be included for providing table lookup or a non-linear function in a finite impulse response (FIR) equalizer. The idea is implemented in the non-linear equalizers shown in FIGS. 8 and 9.

FIG. 8 shows read signal equalization. A read signal is entered on input 80 to a linear equalizer 81. The equalizer is optimized for a predefined pulse as discussed above. A non linear equalizer 89 for reducing the inter symbol interference is coupled to the linear equalizer 81 and provides an output signal to a linearizer 88. The non linear equalizer comprises a number of delay elements 82, 83, 84 having a delay D of one symbol for determining a previous and next signal at the previous and succeeding symbol readout time. The previous and next signal are coupled to ISI calculators 85, 86 for calculating a correction value. The correction values are subtracted from the main signal in summing unit 87. The ISI calculator is based on the model of the channel as discussed above.

FIG. 9 shows an alternative circuit for read signal equalization. The linear equalizer 81, the ISI calculator 85, the summing unit 87 and the linearizer 88 correspond to FIG. 8. The non linear equalizer comprises a different number of delay elements, a first chain of delay elements 91, 92, 93 delays the correction values of a single ISI calculator 85. A second chain of delay elements 94, 95 delays the input signal. The correction values are subtracted from the main signal in summing unit 87.

FIG. 10 shows correction values for an ISI calculator. A curve 101 shows the relation between input and output. A table 102 gives the numerical relation from input to output. The correction values are based on the values shown in FIG. 7 for an equalizer at P=4.5 and the next neighbor n=1.

FIG. 11 shows correction values for a linearizer. A curve 103 shows the relation between input and output. A table 104 gives the numerical relation from input to output. The correction values are based on the values shown in FIG. 7 for an equalizer at p=4.5 and the nominal signal n=0. It is to be noted that the linearizer may also be combined with a detector/discriminator which receives the output value of the read signal after equalization and converts the multilevel read signal in a digital value, e.g. a 3 bit value for each symbol.

It is noted that the equalizer described above is particularly suitable for use in multilevel system in optical recording. However the system is also suitable for other types of recording using different pulse shapes, wherein the equalizer can be optimized for one of the pulse shapes only and further pulses cause residual ISI. Also the system is suitable for read-only systems, because no influence on the write channel is available and equalization can only be applied in the read channel.

In an embodiment the correction values established by the model as discussed above are augmented by read calibration. A record carrier may be provided with known test patterns, which can be read and analyzed for adapting parameters in the equalizer. Also other learning patterns on a disc or signals detected from data may be used to adapt the equalizer parameters to the actual record carrier.

When concerning a write strategy that aims at equidistant readout levels, it appears that levels corresponding to pulses which are shorter than the pulse length for which the equalizer was designed are too high. The levels corresponding to pulses which are longer than the pulse length for which the equalizer was optimized are too low. Traditionally this could be compensated by precompensation in the write channel, e.g. by reducing the length of the shorter pulses and increasing the length of the longer pulses. However, this brings the following disadvantages.

1. It may be hard to reduce the length of the shortest effects for technical reasons.

2. It is not possible to increase the length of the longest effects as they are already at maximal length (symbol length).

3. ISI will deteriorate, due to the sign of the ISI. Thus linearity optimization and ISI cancellation are basically conflicting. A flier disadvantage might be that if the effect lengths are not equidistantly spaced anymore, they might be harder to distinguish in case of jitter on their edges due to media noise.

For the write channel according to the invention, the system of subdividing the mark into (at least) two mark sections and one intermediate spacing section provides an option for reducing ISI and linearizing. A model for the write channel having a subdivided mark can be mathematically described as follows. The overall length 32 of the sequence of mark sections is called Dₒᵥₑᵣₐₗₗ, whereas the spacing 35 is called D_{spacing}. The function of pulse modulator 52 in the model of FIG. 5 can be written as:

$${c}_{p}^{′} ( t ) = {\prod }_{}^{} ( \frac{t}{{D}_{overall}} ) - {\prod }_{}^{} ( \frac{t}{{D}_{spacing}} ) \\ ⟷ \\ {C}_{p}^{′} ( f ) = \frac{sin ( π {fD}_{overall} )}{π f} - \frac{sin ( π {fD}_{spacing} )}{π f}$$

Instead of one parameter (duration), there are now two parameters (overall duration 32 and spacing 35). The read signal now follows from the read model response function as:

$$y ( t ) = {ℱ}^{- 1} \{ \frac{{RC}_{β } ( f )}{{C}_{e} ( f )} {C}_{p}^{′} ( f ) \}$$

The two parameters 32,35 can be tuned for cancellation of non-linearity and nearest neighbor ISI simultaneously. It is shown that Doverall=0.8 T, Dspacing=0.3 T is close to optimal, as shown in FIG. 4. Pulses of other length may be optimized likewise.

It is to be noted that there is a relation between the selection of the equalizer and the residual ISI. When a specific selection of equalizer is predefined for the read channel, the optimization of the above write strategy power patterns can be adapted to that equalizer. Hence the power patterns defined for the different marks are adapted to a presumed read channel and equalizer. From the table in FIG. 7 it appears that if the equalizer is optimized for the longest pulse length, the main non-linear ISI and nonlinearity is associated with the pulses of moderate length, which can best be subdivided. Hence preferably the equalizer is optimized for a longer, in particular the longest, mark. The power pattern for writing the longest mark can be optimized for maximum read signal, i.e. not subdividing the mark but writing a continuous mark of maximum length and intensity.

In an embodiment of the device according to the invention the control unit has a calibration function for adjusting parameters in the write strategy, usually called optimum power control (OPC). For example the calibrating may be done when writing actual data, which is called running OPC. OPC may also be performed using dedicated test patterns during a special mode of the device, for example during start-up. Alternatively writing user data may be temporarily interrupted for performing a calibration procedure using test patterns, called walking OPC. During OPC the resulting read signals are detected and used to adjust parameters in the write strategy. In a startup mode the settings may be retrieved from pre-recorded recording information on the record carrier, or from a predefined write strategy in a memory of the device. In a calibration mode later on, e.g. in a background process, known settings can be used as a reference, e.g. settings determined earlier when recording previous test patterns.

Although the invention has been explained mainly by embodiments using the multilevel optical recording systems, the invention can be used for binary recording systems also, e.g. for controlling the location of the zero crossings of the read signal. The additional control of creating a sub-divided mark detected during reading as a single mark provides an additional degree of freedom for improving a variety of parameters of the channel of a storage system. It is noted that in this document the word recordable includes re-writable and recordable once. Also for the information carrier an optical disc has been described, but other media, such as optical card or magnetic tape, may be used. It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ may be represented by the same item of hardware. Further, the scope of the invention is not limited to the embodiments, and the invention lies in each and every novel feature or combination of features described above.

1. Device for recording information in a track (11) on a record carrier (4), the device comprising:
a head (22) for generating a beam of radiation for writing and reading marks,
radiation source control means (29) for generating power patterns for controlling the power of the radiation source during writing of marks having a number of different shapes for representing the information,
the power pattern for at least one of the different shapes comprising a first pulse part for writing a first mark section and a second pulse part for writing a second mark section, and an intermediate pulse part for creating a spacing section between the first and second mark sections, and the sections of the mark being detectable as a single mark during said reading.

2. Device as claimed in claim 1, wherein the radiation source control means (29) are for generating the power patterns for generating different levels of a read signal at a read-out time for said number of different shapes.

3. Device as claimed in claim 1, wherein the radiation source control means (29) are for generating the power patterns adapted for repressing interference from preceding or succeeding marks in dependence of a predefined read channel.

4. Device as claimed in claim 3, wherein the power patterns are generated for said repressing in dependence of a predetermined read signal equalizing function.

5. Device as claimed in claim 4, wherein said number of different shapes comprises longer and shorter shapes, and the predetermined read signal equalizing function is adapted to improve the read signal for the longer shapes, in particular optimized for the longest shape.

6. Device as claimed in claim 1, wherein said number of different shapes comprises a longest shape, and the radiation source control means (29) are for generating the power pattern for the longest shape as a continuous mark without a spacing section.

7. Device as claimed in claim 1, wherein said number of different shapes comprises a shortest shape, and the radiation source control means (29) are for generating the power pattern for the shortest shape as a continuous mark without a spacing section.

8. Device as claimed in claim 1, wherein the radiation source control means (29) are for generating the power pattern for at least one of the different shapes comprising at least one further pulse part for writing a further mark section and at least one further intermediate pulse parts for creating a further spacing section.

9. Method of controlling the power of a radiation source during recording information in a track on a record carrier, the method comprising:
generating power patterns for controlling the power of the radiation source during writing of marks having a number of different shapes for representing the information, the power pattern for at least one of the different shapes comprising a first pulse part for writing a first mark section and a second pulse part for writing a second mark section, and an intermediate pulse part for creating a spacing section between the first and second mark sections, and the sections of the mark being detectable as a single mark during said reading.

10. Record carrier comprising a track which comprises marks having a number of different shapes for representing information, at least one of the different shapes comprising a first mark section, a second mark section, and a spacing section between the first and second mark sections, and the sections of the mark being detectable as a single mark during reading.
